(19) United States
(12) Patent Application Publication
(10) Pub. No.: US 2010/0111578 A1
(43) Pub. Date: May 6, 2010

(54) APPARATUS FOR CLEANING FUSER ROLL

(75) Inventors: John E. Derimiggio, Fairport, NY (US); Paul M. Fromm, Rochester, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 12/262,637

(22) Filed: Oct. 31, 2008

(51) Int. Cl. G03G 15/20

(52) U.S. Cl. 399/327

(57) ABSTRACT

In a printer for forming toner images on a photoreceptor, the printer including a heated fuser roll with an elastomer-coated surface, an external heating roll, in contact with the heated fuser roll, the external heating roll includes a braking mechanism for generating frictional contact with the heated fuser roll thereby improving fuser cleaning

### BACKGROUND

Described herein are methods for optimizing release agents for the fusing of electrostatic toner particles. More specifically, herein is described an apparatus for cleaning fuser roll.

In a typical electrostatographic reproducing apparatus, a light image of an original to be copied is recorded in the form of an electrostatic latent image upon a photosensitive member, and the latent image is subsequently rendered visible by the application of electroscopic thermoplastic resin particles and pigment particles, or toner. The visible toner image is then in a loose powdered form and can be easily disturbed or destroyed. The toner image is usually fixed or fused upon a support, which can be the photosensitive member itself, or some other support sheet such as plain paper.

The use of thermal energy for fixing toner images onto a support member is well known. To fuse electroscopic toner material onto a support surface permanently by heat, it is usually necessary to elevate the temperature of the toner material to a point at which the constituents of the toner material coalesce and become tacky. This heating causes the toner to flow to some extent into the fibers or pores of the support member. Thereafter, as the toner material cools, solidification of the toner material causes the toner to be bonded firmly to the support.

Typically, the thermoplastic resin particles are fused to the substrate by heating to a temperature of from about 90° C. to about 200° C. or higher, depending on the softening range of the particular resin used in the toner. It may be undesirable, however, to increase the temperature of the substrate substantially higher than about 250° C. because of the tendency of the substrate to discolor or convert into fire at such elevated temperatures, particularly when the substrate is paper.

Several approaches to thermal fusing of electroscopic toner images have been described in the literature. These methods include providing the application of heat and pressure substantially concurrently by various means, a roll pair maintained in pressure contact, a belt member in pressure contact with a roll, a belt member in pressure contact with a heater, and the like. Heat can be applied by heating one or both of the rolls, plate members, or belt members. Fusing of the toner particles occurs when the proper combination of heat, pressure, and/or contact for the optimum time period are provided. The balancing of these variables to bring about the fusing of the toner particles is well known in the art, and can be adjusted to suit particular machines or process conditions.

During the operation of one fusing system in which heat is applied to cause thermal fusing of the toner particles onto a support, both the toner image and the support are passed through a nip formed between a pair of rolls, plates, belts, or combination thereof. The concurrent transfer of heat and the application of pressure in the nip affects the fusing of the toner image onto the support. It is desired in the fusing process that minimal or no offset of the toner particles from the support to the fuser member takes place during normal operations. Toner particles offset onto the fuser member can subsequently transfer to other parts of the machine or onto the support in subsequent copying cycles, thereby increasing the image background, causing inadequate copy quality, causing inferior marks on the copy, or otherwise interfering with the material being copied there as well as causing toner contamination of other parts of the machine. The referred to “hot offset” occurs when the temperature of the toner is increased to a point where the toner particles liquefy and a splitting of the molten toner takes place during the fusing operation with a portion remaining on the fuser member. The hot offset temperature or degradation of the hot offset temperature is a measure of the release properties of the fuser member, and accordingly it is desirable to provide a fusing surface having a low surface energy to provide the necessary release.

To ensure and maintain good release properties of the fuser member, it has become customary to apply release agents to the fuser member during the fusing operation. Typically, these materials are applied as thin films of, for example, silicone oils, such as polydimethyl siloxane, or substituted silicone oils, such as amino-substituted oils, or the like, to prevent toner offset. In addition, fillers can be added to the outer layers of fuser members to increase the bonding of the fuser oil to the surface of the fuser member, thereby imparting improved release properties.

The fuser roll used in the fuser roller system eventually becomes contaminated with a film or debris containing toner or by-products of toner and paper. This contamination usually takes the form of a film which eventually builds up and adversely affects the performance and life of the fuser roll.

This fuser roll contamination can generally occur in any fuser system of an electrophotographic printer or copier, and it causes marks on copy (MOC) in addition to marks caused by prior image history. Generally, the fuser roll becomes contaminated, as earlier noted, with toner and by-products of fuser chemical reactions which eventually can cause early failure of the entire fusing system. There is no known convenient, practical solution to this fuser roll contamination due to competing affects of control factors.

Problems with toner debris on the fuser roller can eventually affect the pressure roll and also the quality and clarity of the imaged paper in contact with the fuser roller. As noted above, the life of the relatively expensive fuser roll can be substantially shortened if this contamination problem is not properly addressed.

### SUMMARY

The present disclosure obviates the problems noted above by providing a printer for forming toner images on a photoreceptor, the printer including a heated fuser roll with an elastomer-coated surface, an external heating roll, in contact with said heated fuser roll, said external heating roll includes a braking mechanism for generating frictional contact with said heated fuser roll thereby improving fuser cleaning

### BRIEF DESCRIPTION OF THE DRAWINGS

FIG. 1 illustrates a fusing system in accordance with an embodiment herein.

FIG. 2 is an illustration of a general electrostatographic apparatus.

### DETAILED DESCRIPTION

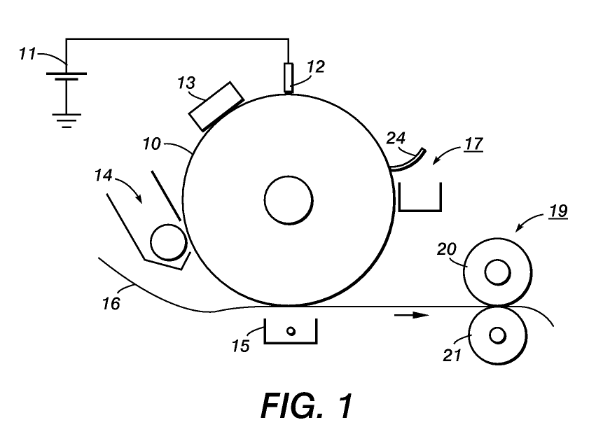

Referring to FIG. 1, in a typical electrostatographic reproducing apparatus, a light image of an original to be copied is recorded in the form of an electrostatic latent image on a photosensitive member, and the latent image is subsequently rendered visible by the application of electroscopic thermoplastic resin particles, commonly referred to as toner. Specifically, photoreceptor 10 is charged on its surface by means of a charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process.

After the toner particles have been deposited on the photoconductive surface in image configuration, they are transferred to a copy sheet 16 by transfer means 15, which can be pressure transfer, electrostatic transfer, or the like. Alternatively, the developed image can be transferred to an intermediate transfer member and subsequently transferred to a copy sheet.

After transfer of the developed image is completed, copy sheet 16 advances to fusing station 19, depicted in FIG. 1 as fusing and pressure rolls, wherein the developed image is fused to copy sheet 16 by passing copy sheet 16 between fusing member 20 and pressure member 21, thereby forming a permanent image. Photoreceptor 10, subsequent to transfer, advances to cleaning station 17, wherein any toner left on photoreceptor 10 is cleaned therefrom by use of a blade, brush, or other cleaning apparatus.

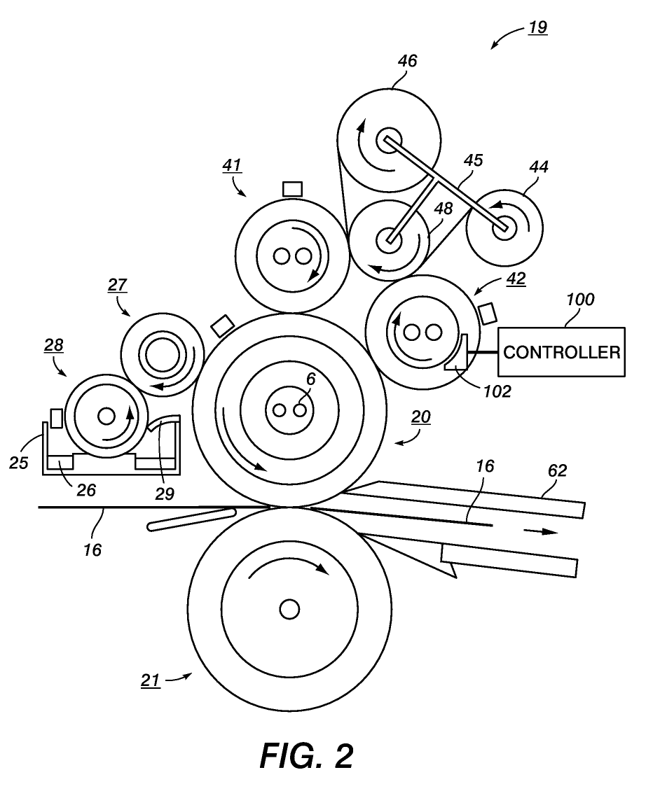

Referring to FIG. 2, an embodiment of a fusing station 19 is depicted with an embodiment of a fuser roll 20 comprising polymer surface on a suitable base member or substrate, which in this embodiment is a hollow cylinder or core fabricated from any suitable metal, such as aluminum, anodized aluminum, steel, nickel, copper, or the like, having a suitable heating element disposed in the hollow portion thereof which is coextensive with the cylinder. The fuser roll 20 optionally can include an adhesive, cushion, or other suitable layer positioned between core and outer layer. Backup or pressure roll 21 cooperates with fuser roll 20 to form a nip or contact arc through which a copy paper or other substrate 16 passes such that toner images thereon contact polymer or elastomer surface of fuser roll 20. As shown in FIG. 2, an embodiment of a backup roll or pressure roll 21 is depicted as having a rigid steel core with a polymer or elastomer surface or layer thereon. Sump 25 contains polymeric release agent 26, which may be a solid or liquid at room temperature, but is a fluid at operating temperatures, and, can be a mixture of an amino-substituted organosiloxane polymer and a nonfunctional organosiloxane polymer. The pressure roll 21 can also optionally include a heating element (not shown).

In the embodiment shown in FIG. 2 for applying the polymeric release agent 26 to polymer or elastomer surface, two release agent delivery rolls 27 and 28 rotatably mounted in the direction indicated are provided to transport release agent 26 to polymer or elastomer surface. Delivery roll 28 is partly immersed in the sump 25 and transports on its surface release agent from the sump to the delivery roll 27. By using a metering blade 29, a layer of polymeric release fluid can be applied initially to delivery roll 27 and subsequently to polymer or elastomer in controlled thickness ranging from submicron thickness to thicknesses of several microns of release fluid. Thus, by metering blade 29, from about 0.1 to about 2 microns or greater thicknesses of release fluid can be applied to the surface of polymer or elastomer.

The term “fuser member” as used herein refers to fuser members including fusing rolls, belts, films, sheets, and the like; donor members, including donor rolls, belts, films, sheets, and the like; and pressure members, including pressure rolls, belts, films, sheets, and the like; and other members useful in the fusing system of an electrostatographic or xerographic, including digital machine. The fuser member can be employed in a wide variety of machines, and is not specifically limited in its application to the particular embodiment depicted herein.

Any suitable substrate can be selected for the fuser member. The fuser member substrate can be a roll, belt, flat surface, sheet, film, or other suitable shape used in the fixing of thermoplastic toner images to a suitable copy substrate. It can take the form of a fuser member, a pressure member, or a release agent donor member, and can be in the form of a cylindrical roll. Typically, the fuser member is made of a hollow cylindrical metal core, such as copper, aluminum, stainless steel, or certain plastic materials chosen to maintain rigidity and structural integrity, as well as being capable of having a polymeric material coated thereon and adhered firmly thereto. It is desired that the supporting substrate is a cylindrical sleeve, and can be with an outer polymeric layer of from about 0.1 to about 10 millimeters. In one embodiment, the core, which can be an aluminum or steel cylinder, is degreased with a solvent and cleaned with an abrasive cleaner prior to being primed with a primer, such as Dow Corning® 1200, which can be sprayed, brushed, or dipped, followed by air drying under ambient conditions for thirty minutes and then baked at 150° C. for 30 minutes.

Referring back to FIG. 2, external heat rolls 41 and 42 provide additional heat to fuser roll 20. External heat rolls 41 and 42 are a hollow cylinder or core fabricated from any suitable metal, such as aluminum, anodized aluminum, steel, nickel, copper, or the like, having a suitable heating element disposed in the hollow portion thereof which is coextensive with the cylinder. Cleaning system 19 cleans external heat rolls 41 and 42, cleaning system 19 includes supply roll 44 which holds web material and take-up 46 which retrieves the used web material. Roll 48 urges the web material into contact with external heat rolls 41 and 42.

Applicants have found that using external heat rolls 41 and 42 having a roughened surface improves abrasion between the external heat roll and fuser roll which enhances the cleaning of the fuser roll thereby extending fuser roll life. To further increase the abrasion between the roughened external heat roll and the fuser roll by applying a mechanical braking mechanism 102 to the external heat roll rotation.

A braking force or torque is applied to one or both of the external heat rolls during this engagement period in order to force a slip or skid between the external heat rolls and the fuser roller. During printing mode the external heat rolls rides idle on the surface of the fuser roll with little resistance. During a cleaning mode, braking mechanism 102 induces resistance to the rotation of the heat roll, providing slippage between the heat roll and fuser roll, resulting in increased abrasion. Braking mechanism 102 can take several forms ranging from passive loads (inducing momentary or sustained drag) to active electro-mechanical clutches can be utilized. A controller 100 can control drag amount and timing which both can be varied. The braking force can be a single momentary brake or a relatively high frequency pulse that will ‘chatter’ the external rolls against the fuser roller.

Other embodiments and modifications may occur to those of ordinary skill in the art subsequent to a review of the information presented herein; these embodiments and modifications, as well as equivalents thereof, are also included within the scope of this invention.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. In a printer for forming toner images on a photoreceptor, the printer including:
a heated fuser roll with an elastomer-coated surface,
an external heating roll, in contact with said heated fuser roll, said external heating roll includes a braking mechanism for generating frictional contact with said heated fuser roll thereby improving fuser cleaning.

2. The printer of claim 1, further comprising a cleaning system for cleaning the surface of said fuser roll surface while supplying oil to said fuser roll surface, said cleaning system comprising:
a cleaning web mounted on a supply roll,
means for advancing the cleaning web.

3. The printer of claim 1, further comprising a controller for engaging and disengaging said braking mechanism.

4. The printer of claim 3, wherein said controller engaging said braking mechanism when said printer is in a non printing mode.

5. The printer of claim 3, wherein said braking mechanism applies a continuous braking force.

6. The printer of claim 1, wherein said external heating roll has a substantially rough surface.

7. The printer of claim 1, wherein said external heating roll has a cleaning system for cleaning the surface of said external heating roll.

8. The printer of claim 4, wherein said controller controls drag amount and applied timing of braking force.
